(19) United States
(12) Patent Application Publication
(10) Pub. No.: US 2014/0048391 A1
(43) Pub. Date: Feb. 20, 2014

(54) UNIT FOR CONTAINER RETURN MACHINES

(71) Applicant: Dieter Beyer, Friedersdorf (DE)

(72) Inventor: Dieter Beyer, Friedersdorf (DE)

(21) Appl. No.: 13/985,962

(22) PCT Filed: Feb. 17, 2012
(86) PCT No.: PCT/DE2012/000149

§ 371 Date: Oct. 25, 2013

(30) Foreign Application Priority Data
Feb. 18, 2011 (DE) 10 2011 011 726.1

(51) Int. Cl. B65G 19/02

(52) U.S. Cl. CPC B65G 19/02
USPC 198/836.1

(57) ABSTRACT

The present invention relates to a unit for container return machines, having a conveying means for the longitudinal drive of a container in the direction of its longitudinal axis, and a rotational body arranged on each side of the conveying means, wherein, when the unit is in transportation mode, the container rests on the conveying means and is driven longitudinally, and, when the unit is in identification mode, the container rests on the rotational bodies and is driven rotationally. Each rotational body has the cross-section of a flattened circle, such that when the unit is in transportation mode, the container bears against at least one of the flattened surfaces of the rotational bodies.

### RELATED APPLICATIONS

This application is a national stage application of International Application No. PCT/DE2012/000149, filed Feb. 2, 2012, which claims benefit of German Application No. 10 2011 011 726.1, filed Feb. 18, 2011, the disclosures of each of which are hereby incorporated by reference.

### FIELD

The disclosed embodiments relate to a unit for container return machines.

### BACKGROUND

Various units for container return machines are known, for example, from DE 100 55 206 A1; DE 10 2004 054 284 B4; and DE 10 2009 016 999 B3.

The unit for container return machines disclosed in DE 100 55 206 A1 has a conveyor device in the form of a narrow, continuous conveying belt for longitudinally driving the containers. Two rollers, one on each side of the conveying belt, are driven by a rotary driver extending in the longitudinal direction of the conveying belt. At their two ends, said rollers are rotatably supported at levers that are hinged to the housing of the unit to swivel therewith. By means of a semi-rotary drivers that acts on the levers, the rollers can be moved toward the conveying belt and/or away from the conveying belt on a respective circular path. When the unit is operating in transport function, a container is positioned on the conveying belt and supported laterally by the rollers. A recognition unit is arranged above the conveying belt, which detects, among other things, specific data arranged on the container, for example in form of barcodes, safety identification, etc. If the container is positioned on the conveying belt and the data to be collected is within the field of vision of the recognition unit, the data is collected and the container is pulled into the machine for further processing by driving the conveying belt, or else a signal is generated to remove the container from the machine if said container was not recognized as belonging to the respective deposit system.

If the data to be collected on a container is not within the field of vision of the recognition unit after the container has been inserted, the unit is converted into its identification function. To that end, the two rollers are rotated toward one another, which causes the container to be lifted off the conveying belt. At the same time, the rollers and therefore the container positioned on them are rotated so that the container data to be collected moves into in the field of vision of the recognition unit. After the data has been collected, the rollers are rotated back into their original position so that the container is again positioned on the conveying belt. The process then continues as described above.

The unit for container return machines described in DE 10 2004 054 284 B4 also has a continuous conveying means with a respective rotationally driven roller arranged on each longitudinal sides. However, unlike the solution described in connection with DE 100 55 206 A1, said rollers are stationary. When the unit is in transport function, a container is positioned on the conveying means and laterally supported by the rollers. For the identification function, the complete conveying means is rotated downward so that the container is positioned on the two rollers. With the rotary drive of the rollers, the container is rotated about its longitudinal axis so that a barcode, etc. affixed on its circumference can be recognized.

A disadvantage of the aforementioned units for container return machines is that parts of the unit have to be rotated to realize the transport function and/or the identification function. The mechanisms required for this complicate the setup of the unit.

The disadvantages described above are eliminated with the unit for container return machines disclosed in DE 10 2009 016 999 B3. Said unit does not require any rotating or lifting mechanisms for the rollers and/or the conveying means. To change from the identification function to the transport function and vice versa, the driver of the conveying means, which is available anyway, is utilized. In its longitudinal direction, said conveying means is divided into two segments: a first segment of a lesser thickness, and a second segment of a greater thickness. If the unit is in identification mode, the first segment of the conveying means, meaning the thinner segment, is arranged below the container without contacting the container, i.e., spaced away from said container. The conveying means is not being driven at that time. In this situation, the container can be rotated by the rotary drive on and by the rollers, undisturbed by the conveying means. From said identification function, the transport function is reached by simply turning on the conveying means. The second segment of the conveying means then reaches the area underneath the container. Because the second segment is thicker than the first, the conveying plane is lifted due to the drive motion of the conveying means. The difference in thickness between the first and the second segment of the conveying means is chosen such that the container is lifted slightly from the rollers when it comes into contact with the second segment, and is therefore driven longitudinally and supported laterally by the rollers.

The above-referenced units, however, are mechanically complicated. Therefore, a need exists for an unit for container return machines which is constructed in a simple manner and retains its full functionality.

### SUMMARY

Disclosed embodiments include units for container return machines.

In certain embodiments, the unit for container return machines does not require any rotating or lifting mechanisms for the rotational bodies and/or the conveying means. To change from the identification function into the transport function and vice versa, the rotational bodies, which are available anyway, are utilized. Said rotational bodies have the form of a longitudinally flattened cylinder, i.e., when viewed transversely to their longitudinal axis, they have the cross-section of a circle reduced by a circle segment.

When the unit is in transport mode, a container to be processed is positioned on the conveying means and supported on at least one of the flattened surfaces of the rotational bodies. When the rotary driver of the rotational bodies is activated, the container is lifted off the conveying means as soon as it comes free from the flattened surfaces of the rotational bodies, and remains separated from the conveying means as long as it is in contact with the curved surfaces of the rotational bodies during the rotary motion of the rotational bodies. When the container comes into contact with the flattened surfaces again during the rotary motion of the rotational bodies, it is briefly lowered back onto the conveying means, and then lifted off the conveying means again.

The rotational bodies are being driven in the same direction and therefore transmit a torque that acts in the same direction of rotation on the container, which then also rotates. Because of said rotary motion, any data on the container, such as a barcode, for example, is displayed in the field of vision of a recognition unit. After the recognition unit has collected the data, the rotary drive of the rotational bodies is stopped in such a way that the container again rests on the flattened surface(s) of the two rotational bodies, with said container being supported simultaneously by the conveying means. When the unit is in transport mode, the flattened surfaces of the rotational bodies only have a stabilizing effect so that the container cannot fall off the conveying means at the side. Then the drive of the conveying means is activated so that the container is transported further into the direction of its longitudinal axis.

In certain embodiments, to transmit a sufficient torque from the rotational bodies to the container, it is advantageous if the curved surfaces of the rotational bodies are comprised of a material and/or a coating that has a high friction quotient. This can be achieved with gumming, for example.

In certain embodiments, to keep resistance to a minimum when the container is transported longitudinally by the conveying means, it is useful to develop the flattened surfaces of the rotational bodies in such a fashion that they have a small friction quotient. This can be achieved with a Teflon coating, for example.

Finally, in another embodiment of the invention, the conveying means is developed as a circular belt. Said cross-sectional form of the conveying means ensures that the container is supported on the flattened surface, or on one of the flattened surfaces, of the rotational bodies in a stabilizing manner during the longitudinal transport of a container, and that the conveying means offers as little resistance as possible to the rotary motion of the container in the rotary drive of the container.

Additional objects and advantages of the disclosed embodiments will be set forth in part in the description which follows, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various embodiments and aspects of the disclosed embodiments. Together with the description, the drawings serve to explain the principles of the disclosed embodiments

In the drawings:

FIG. 1 illustrates a perspective frontal view of a unit in transport mode,

FIG. 2 illustrates a frontal view of the exemplary embodiment according to FIG. 1 on a reduced scale,

FIG. 3 illustrates a representation according to FIG. 2 when the unit is in identification mode.

### DETAILED DESCRIPTION

Reference will now be made in detail to disclosed embodiments, examples of which are illustrated in accompanying drawings. Whenever convenient, the same reference numbers will be used throughout the drawings to refer to the same or like parts.

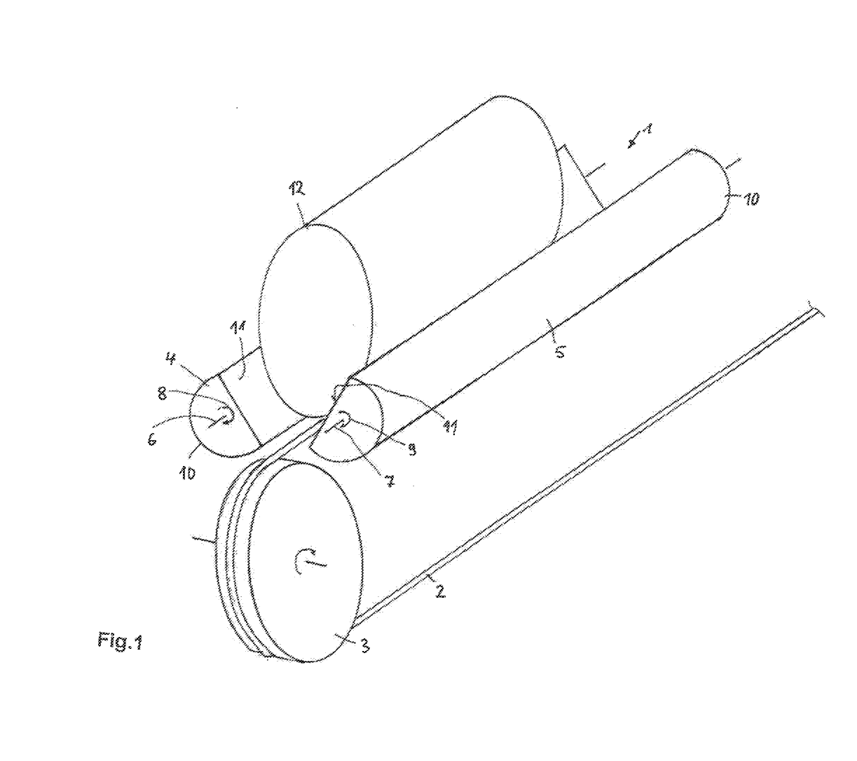

The unit shown in FIG. 1 is arranged in a return machine for empty beverage containers [not shown]. It has a transport function as well as an identification function, as will be explained in the following.

As shown in exemplary FIG. 1, the conveying means of unit 1 may be circular belt 2. Circular belt 2 is guided over front deflection roller 3, a rear deflection roller (not shown), which at the same time also functions as drive roller, as well as a tension roller (also not shown). The transportation section of circular belt 2 runs between two rotational bodies, rotation body 4 and rotational body 5, with one rotational body arranged on each side. Rotational bodies 4 and 5 can be placed into rotary motion about their longitudinal axes 6 and 7 via drivers (not shown). Specifically, rotational bodies 4 and 5 are rotated in the same direction, as indicated by arrows 8 and 9.

Rotational bodies 4, 5 may be longitudinally flattened cylinders. That is, when viewed transversely to their longitudinal axes, each has the cross-section of a circle reduced by a circle segment. Therefore, each rotational body 4, 5 has curved surface 10 that follows a circular line, and flattened surface 11.

In certain embodiments, the unit may operate as follows:

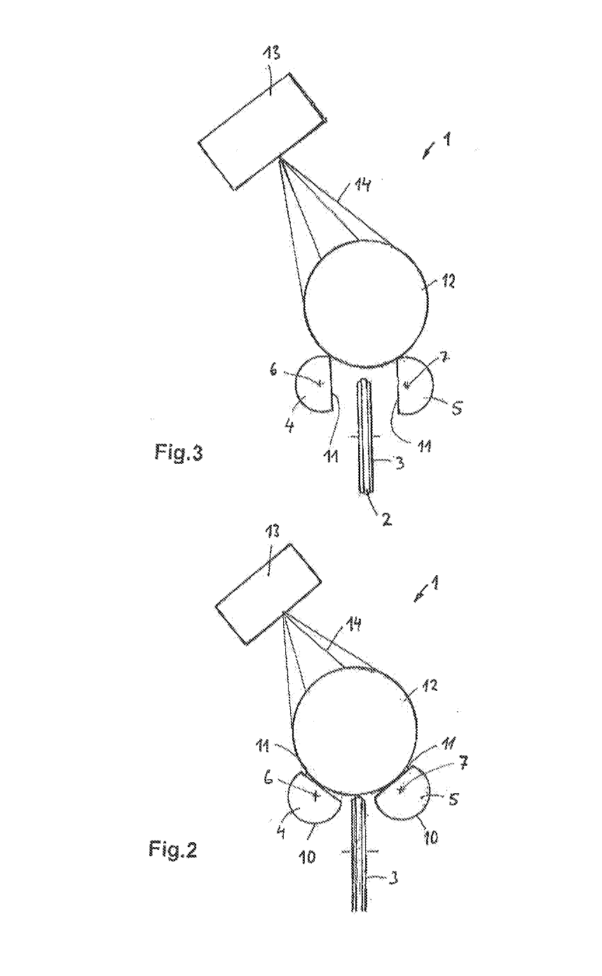

When unit 1 is in transport function (FIGS. 1 and 2), a container, such as can 12, is inserted into the return machine through an input opening and positioned on rotational bodies 4 and 5 as well as circular belt 2. Rotational bodies 4 and 5 are at least initially not moving and circular belt 2 is also idle. Above can 12, detection unit 13 (FIGS. 2 and 3), such as a barcode scanner, is arranged to detect a barcode arranged on can 12.

There are two different scenarios with respect to the mode of operation of unit 1:

In a first scenario, can 12 is inserted by a customer in such a way that the barcode is in field of vision 14 of detection unit 13. The barcode can then be detected immediately by detection unit 13, and the collected data can be forwarded to an evaluation unit. Can 12 may then be conveyed into the return machine by activating the drive of circular belt 2.

In the second scenario, the barcode of inserted can 12 is not in field of vision 14 of detection unit 13, which makes it necessary to rotate can 12. To that end, the drive of rotational bodies 4 and 5 is activated so that can 12 rotates about its longitudinal axis due to the friction between can 12 and rotational bodies 4 and 5. In said rotary motion, can 12 is alternately lifted off and lowered onto circular belt 2. The aforementioned identification mode of unit 1 is shown in FIG. 3. Because of the rotary motion of can 12, the barcode reaches field of vision 14 of detection unit 13 and can be detected.

After the barcode arranged on can 13 has been detected, unit 1 resumes its transport function (FIGS. 1 and 2). In that situation, can 12 is positioned on circular belt 2 and supported on both sides or on one side by flattened surfaces 11 of rotational bodies 4 and 5. Then the driver for circular belt 2 is activated. The frictional engagement between circular belt 2 and can 12 is then significantly greater than the frictional engagement of can 12 and flattened surfaces 11 of rotational bodies 4 and 5. Can 12 is therefore conveyed into the return machine by circular belt 2 for further processing.

1-5. (canceled)

6. A unit for a contain return machine, wherein the unit comprises:
(1) a conveying means for longitudinally driving a container in the direction of its longitudinal axis;
(2) two rotational bodies, each rotational body arranged at each side of the conveying means, and each rotational body having a cross-section of a circle reduced by a circle segment such that each rotational body has a curved longitudinal surface and a flat longitudinal surface;
wherein a container placed on the conveying means may be driven longitudinally when the unit is in transportation mode,
wherein a container placed on the rotational bodies may be driven rotationally when the unit is in identification mode, and
wherein a container placed on the conveying means is supported by at least one of the flat surfaces of the rotational bodies when the unit is in transportation mode.

7. The unit of claim 6, wherein the height of the circular segment of at least one rotational body corresponds to approximately one third of the diameter of the circle of the cross-section of the at least one rotational body.

8. The unit of claim 6, wherein the curved surface of at least one rotational body is comprised of a material or comprises a coating that has a high friction coefficient.

9. The unit of claim 7, wherein the curved surface of at least one rotational body is comprised of a material or comprises a coating that has a high friction coefficient.

10. The unit of claim 6, wherein at least one flattened surface of the rotational bodies has a low friction coefficient.

11. The unit of claim 7, wherein at least one flattened surface of the rotational bodies has a low friction coefficient.

12. The unit of claim 8, wherein at least one flattened surface of the rotational bodies has a low friction coefficient.

13. The unit of claim 9, wherein at least one flattened surface of the rotational bodies has a low friction coefficient.

14. The unit according to claim 6, wherein the conveying means is a circular belt.

15. The unit according to claim 7, wherein the conveying means is a circular belt.

16. The unit according to claim 8, wherein the conveying means is a circular belt.

17. The unit according to claim 9, wherein the conveying means is a circular belt.

18. The unit according to claim 10, wherein the conveying means is a circular belt.

19. The unit according to claim 11, wherein the conveying means is a circular belt.

20. The unit according to claim 12, wherein the conveying means is a circular belt.

21. The unit according to claim 13, wherein the conveying means is a circular belt.
